(19) United States
(12) Patent Application Publication
(10) Pub. No.: US 2023/0153646 A1
(43) Pub. Date: May 18, 2023

(54) INDENTIFYING RELEVANT GRAPH PATTERNS IN A KNOWLEDGE GRAPH BACKGROUND

(71) Applicant: INTERNATIONAL BUSINESS MACHINES CORPORATION, Armonk, NY (US)

(72) Inventors: Joern PLOENNIGS, Dublin (IE); Konstantinos SEMERTZIDIS, Thessaloniki (GR); Fabio LORENZI, Tyrrelstown (IE)

(73) Assignee: INTERNATIONAL BUSINESS MACHINES CORPORATION, Armonk, NY (US)

(21) Appl. No.: 17/454,909

(22) Filed: Nov. 15, 2021

(51) Int. Cl. G06N 5/04; G06N 5/02

(52) U.S. Cl. CPC G06N 5/04; G06N 5/02

(57) ABSTRACT

Various embodiments are provided for identifying relevant graph patterns in a knowledge graph in a computing environment by a processor. Data elements may be identified from a knowledge graph and associated datasets that is related to one or more nodes of the knowledge graph and external to the knowledge graph. One or more subgraphs may be selected and created based on missing data elements and inferred knowledge data. The knowledge graph may be modified with one or more subgraphs.

### BACKGROUND

The present invention relates in general to computing systems, and more particularly, to various embodiments for identifying relevant graph patterns in a knowledge graph using a computing processor.

### SUMMARY

According to an embodiment of the present invention, a method for identifying relevant graph patterns in a knowledge graph in a computing environment, by one or more processors, in a computing system. Data elements may be identified from a knowledge graph and associated datasets that is related to one or more nodes of the knowledge graph and external to the knowledge graph. One or more subgraphs may be selected and created based on missing data elements and inferred knowledge data. The knowledge graph may be modified with one or more subgraphs.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting various user hardware and cloud computing components functioning in accordance with aspects of the present invention.

FIG. 5 is a block flow diagram depicting identifying relevant graph patterns in a knowledge graph in which aspects of the present invention may be realized.

FIGS. 6A-6G are additional block diagrams depicting an example of identifying relevant graph patterns in a knowledge graph in accordance with aspects of the present invention.

FIG. 7 is a flowchart diagram depicting an exemplary method for identifying relevant graph patterns in a knowledge graph in a computer environment in which aspects of the present invention may be realized.

### DETAILED DESCRIPTION OF THE DRAWINGS

The present invention relates generally to knowledge graph databases in a computing environment. In knowledge graph databases, stored information is represented by means of a knowledge graph which has nodes interconnected by edges. Nodes of the graph represent entities for which entity data, characterizing those entities, is stored in the database. Entities may, for example, correspond to people, companies, devices, etc. More generally, nodes may represent any entity (real or abstract) for which information needs to be stored. The entity data stored for a node may comprise one or more data items, often called “properties” or “property values”, describing particular features of an entity. Edges of the graph represent relationships between entities. An edge connecting two nodes of the graph represents some defined relationship which is applicable to the entities represented by those nodes. A graph may accommodate different relationships between entities, with each edge having a specified type, indicated by an edge name or “label”, signifying the particular relationship represented by that edge. Nodes may also have associated names, or labels, to indicate different types or categories of node corresponding to different entity-types represented in the graph.

Knowledge graphs provide highly efficient structures for representing large volumes of diverse information about interrelated entities. Querying a knowledge graph database involves formulating a query request defining the information needed from the database in such a way that relevant nodes, edges, and properties can be identified, and then following edges in the graph to identify and extract the required data from storage. Knowledge graphs can be conveniently represented using matrices in which non-zero entries signify edges and row and column indices correspond to node identities. The process of identifying and extracting data for a query request can be implemented by performing mathematical operations on such matrices.

However, one of the challenges is when data is stored in one or more data sources, which may be legacy computing systems and databases. This is challenging particularly when trying to search a knowledge graph and data is not directly stored in the knowledge graph, but in files, databases, or data lakes. Thus, a needs exists to provide a solution to integrate data from various legacy applications within one or more systems.

Accordingly, the present invention provides novel solutions to integrate data from various legacy applications within one or more systems using a semantic knowledge graph that models available data in the various legacy applications. The semantic knowledge graph allows to exchange and link data across various applications as well as adequate hybrid cloud solutions without moving the master data, which may be in a legacy computing systems and database.

The semantic knowledge graph allows for selecting relevant data patterns and associated data in a knowledge graphs for digital twins including optional and non-existing data paths and elements. A traversal reasoning operation of the semantic knowledge graph may be performed for identifying relevant parts in the semantic knowledge graph. One or more filters (e.g., a multi-threaded traversal filter) may be used for selecting and prioritizing associated datasets. Temporary elements may be created to cover optional traversals in the semantic knowledge graph. Missing parts in the semantic knowledge graph may be automatically created.

In some implementations, the semantic knowledge graph integrates one or more types of applications and enables querying knowledge and data from the various applications by their semantics and relationships. Implicit knowledge may be inferred to automatically create new subgraphs and automatically link data from the various applications. One or more new datasets may be created such as new derived time series data.

It should be noted, as used herein, a digital twin is a virtual representation of an object or system that spans its lifecycle, is updated from real-time data, and uses simulation, machine learning and reasoning to help decision-making. That is, the digital twin is a virtual model designed to accurately reflect a physical object.

Also, as used herein, aa domain may refer to a knowledge graphs for digital twins (also known as digital threads) that link to related data assets in one or more legacy systems and databases. A semantic knowledge graph may be a graph of nodes and edges with nodes representing instances (e.g., “Temperature Sensor 1”) of semantic classes (e.g., “Temperature Sensor”) and edges representing their interaction. In some implementations, “semantic knowledge graph” may also be used interchangeably with “knowledge” for short.

A subgraph may be part of a graph consisting of connected nodes and edges. A graph pattern may be a search pattern for a subgraph consisting of nodes and edges such as, for example, a “Room.hasData.TempSensor” for selecting all room instances with data attached.

Also, as used herein, “associated data” may refer to data (e.g., timeseries, files, text, images, etc.) that is not directly stored in the knowledge graph, but in files, databases, or data lakes that is associated with nodes in the semantic knowledge graph and for which the semantic knowledge graph knows how to derive the data. e.g., the timeseries of observations of “Temperature Sensor 1”. In some implementations, “data” may also be used interchangeably with “associated data” for short.

In some implementations, various embodiments described herein may provide semantic knowledge graph that integrates various applications. Knowledge and data may be queried from various applications by their semantics and relationships using the semantic knowledge graph. For example, knowledge from a graph and associated data in legacy systems across missing elements may be queried. Implicit knowledge may be inferred to automatically create new subgraphs and automatically link data from the various application. New datasets such as, for example, new derived timeseries may be created.

In some implementations, knowledge may be queried from a graph and associated data in legacy systems across missing elements. Additional or new knowledge in the graph may be inferred to instantiate missing elements. New associated data may be determined and stored in the legacy systems from previously queried knowledge and data.

It should be noted as described herein, the term “intelligent” (or “cognitive/cognition”) may be relating to, being, or involving conscious intellectual activity such as, for example, thinking, reasoning, or remembering, that may be performed using a machine learning. In an additional aspect, cognitive or “intelligent may be the mental process of knowing, including aspects such as awareness, perception, reasoning and judgment. A machine learning system may use artificial reasoning to interpret data from one or more data sources (e.g., sensor based devices or other computing systems) and learn topics, concepts, and/or processes that may be determined and/or derived by machine learning.

In an additional aspect, cognitive or “intelligent” may refer to a mental action or process of acquiring knowledge and understanding through thought, experience, and one or more senses using machine learning (which may include using sensor based devices or other computing systems that include audio or video devices). Cognitive/intelligent may also refer to identifying patterns of behavior, leading to a “learning” of one or more events, operations, or processes. Thus, the intelligent model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term intelligent may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented intelligent operations that approximate a human thought process while enabling a user or a computing system to interact in a more natural manner. An intelligent system may use AI logic, such as NLP based logic, for example, and machine learning logic, which may be provided as specialized hardware, software executed on hardware, or any combination of specialized hardware and software executed on hardware. The logic of the intelligent system may implement the intelligent operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and intelligent; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human intelligent based on experiences.

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service’s provider.
Broad network access: capabilities are available over a network and accessed through standard mechanisms that promote use by heterogeneous thin or thick client platforms (e.g., mobile phones, laptops, and PDAs).
Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

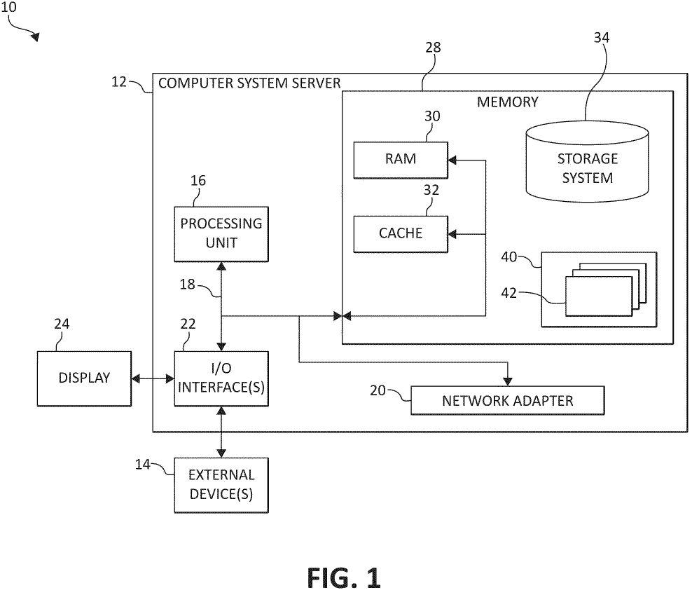

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

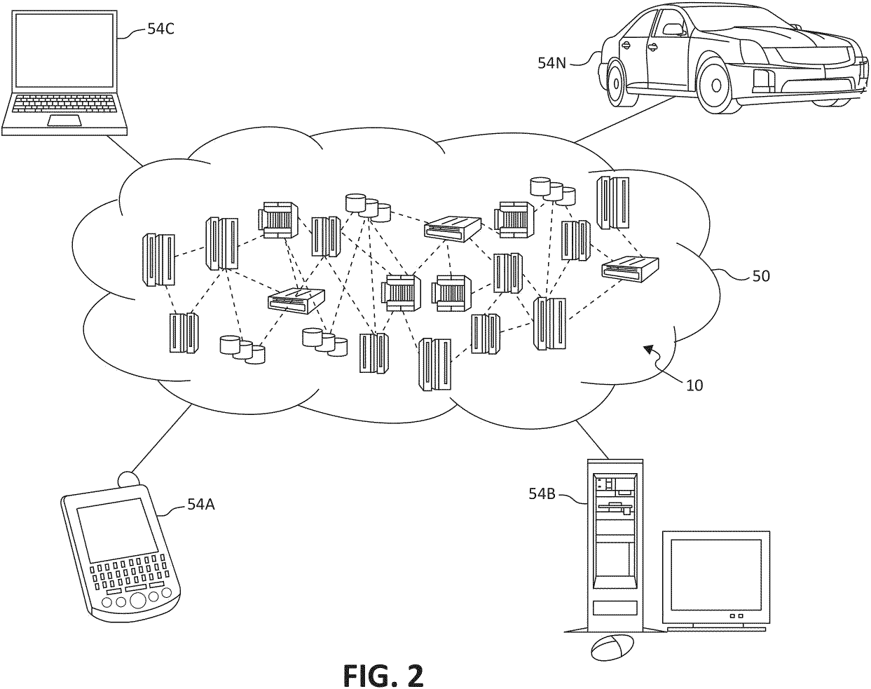

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

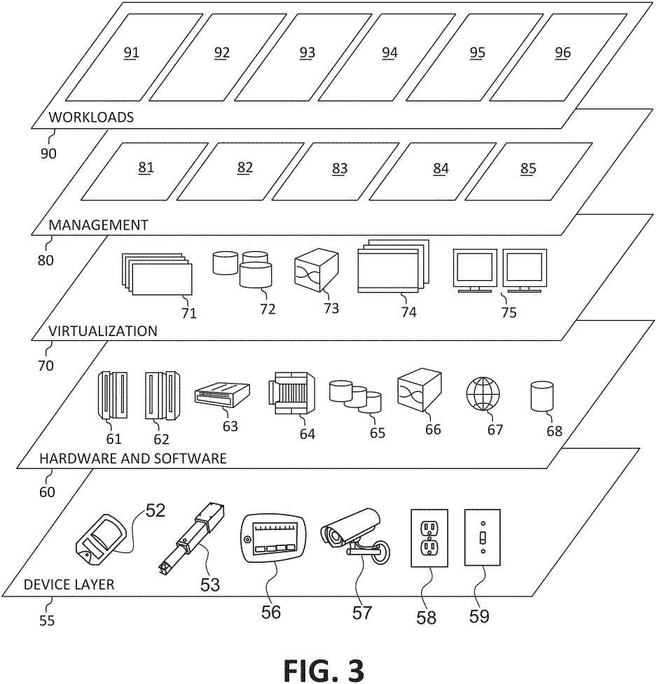

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing a reasonable language model learning for text data in a knowledge graph. In addition, workloads and functions 96 for providing a reasonable language model learning for text data in a knowledge graph may include such operations as data analytics, data analysis, and as will be further described, notification functionality. One of ordinary skill in the art will appreciate that workloads and functions 96 for providing a reasonable language model learning for text data in a knowledge graph may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

Thus, as described herein, in various implementation, the present disclosure provides for providing a reasonable language model learning for text data in a knowledge graph. In some implementations, the present invention provides for selecting and creating relevant patterns and associated data in a knowledge graphs for digital twins including optional and non existing paths and elements by using semantic knowledge graph. The semantic knowledge graph may include T-Box concept nodes defining a term taxonomy and instance nodes of the concepts as A-Box, and respective T-box and A-box relationships (edges). In one aspect, “T-Box” nodes are may be referred to as “concepts” or general knowledge (e.g., a car is a concept (part of T-Box) and the car with plate number xxxxxxxx is an instance (part of the A-Box)).

Data items (e.g., timeseries, documents, etc.) may be associated with these nodes and may reside in external data stores such as, for example, files, databases, data lakes, etc. In one aspect, a T-box is a “terminological one.” The T-Box allows to establish taxonomies of structured terms and answer questions about analytical relationships among these terms. The A-box or “assertional one, allows to establish build descriptive theories of domains of interest and to answer questions about those domains.

Using the semantic knowledge graph, query results, which contain knowledge from the semantic knowledge graph as well as associated data, may be analyzed. A modified knowledge graph may be created by having newly inferred or missing nodes and relationships.

In some implementations, the modified knowledge graph may include one or more new inferred nodes and relationships. New derived associated data such as, for example, new timeseries or documents, may be stored in respective datastores such as, for example, files, databases, and datalakes.

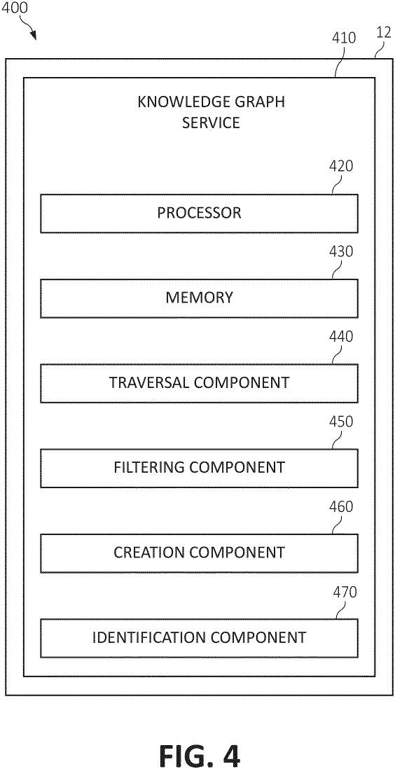

Turning now to FIG. 4, a block diagram depicting exemplary functional components of system 400 for identifying relevant graph patterns in a knowledge graph in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

In one aspect, the computer system/server may provide virtualized computing services (i.e., virtualized computing, virtualized storage, virtualized networking, etc.) to the intelligent conversational agent management and interaction service 402 and the conversation agent 404. More specifically, the computer system/server 12 may provide virtualized computing, virtualized storage, virtualized networking and other virtualized services that are executing on a hardware substrate.

A knowledge graph service 410 is shown, incorporating processing unit 420 (“processor”) to perform various computational, data processing and other functionality in accordance with various aspects of the present invention. In one aspect, the processor 420 and memory 430 may be internal and/or external to the knowledge graph service 410, and internal and/or external to the computing system/server 12. The knowledge graph service 410 may be included and/or external to the computer system/server 12, as described in FIG. 1. The processing unit 420 may be in communication with the memory 430. The knowledge graph service 410 may include a traversal component 440, a filtering component 450, a creation component 460, and an identification component 470.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The traversal component 440, the filtering component 450, the creation component 460, and the identification component 470 may identify data elements from a knowledge graph and associated datasets that is related to one or more nodes of the knowledge graph and external to the knowledge graph; select and create one or more subgraphs based on missing data elements and inferred knowledge data; and modify the knowledge graph with one or more subgraphs.

The traversal component 440 may infer knowledge data in the knowledge graph to instantiate missing data elements absent from the knowledge data. The traversal component 440 may traverse the knowledge graph to identify relationships between the data elements and the associated datasets, wherein a filtering and multi-thread filtering operations are applied.

In some implementations, selecting and creating the one or more subgraphs further includes identifying one or more relevant data patterns and the associated data. The creation component 460 may create one or more temporary data elements and the missing data elements, and create one or more additional associated datasets. The filtering component 450, the creation component 460, and the identification component 470 may apply one or more filters for selecting and prioritizing the associated datasets.

The traversal component 440, the filtering component 450, the creation component 460, and the identification component 470 may identify one or more relationships between data elements and instances in the knowledge graph by traversing the knowledge graph; create one or more placeholders in the knowledge graph based on identifying the one or more relationships between the data elements and the instances; filter the associated datasets; and create one or more new data elements and new associated data based on the filtering and the one or more placeholders.

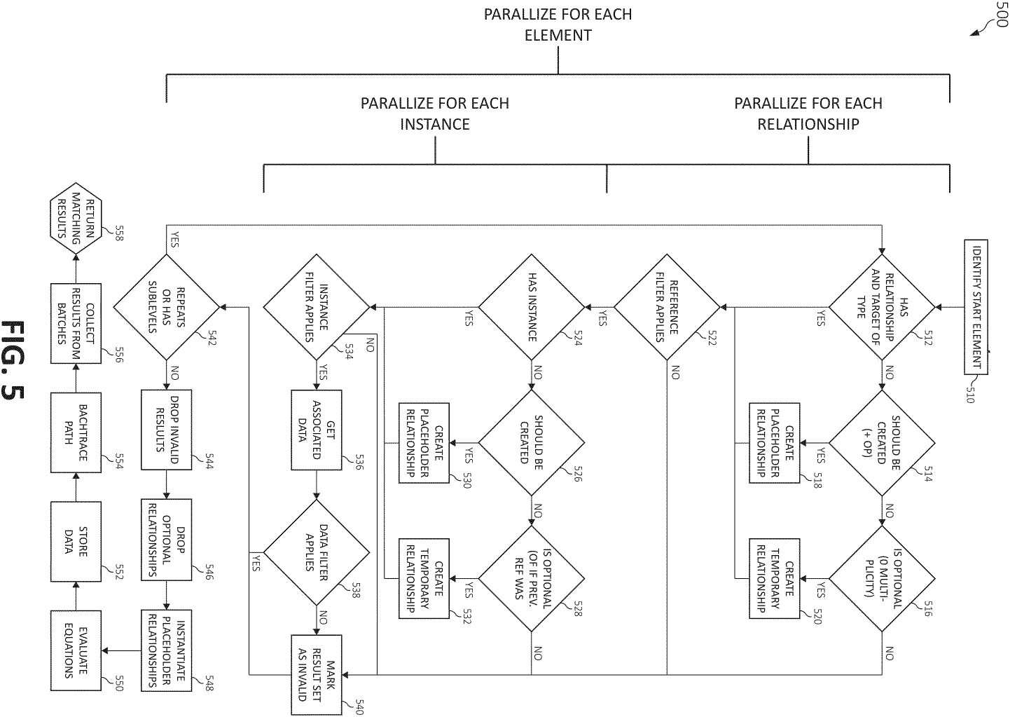

Turning now to FIG. 5, a block-flow diagram of exemplary functionality 500 relating to identifying relevant graph patterns in a knowledge graph is depicted. As shown, the various blocks of functionality are depicted with arrows designating the blocks’ 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for identifying relevant graph patterns in a knowledge graph in accordance with the present invention.

As an overview of FIG. 5, the following may be performed.

In step 1, all relevant entry elements may be identified.

In step 2, for each entry element, parallize-traverse all relationships and create temporary and placeholder ones (if necessary). In one aspect, “traversal” is the process of following some edges between nodes from a starting node to an end node according to some pattern. In some implementations, the present invention may leverage the ability of computers to perform computation in parallel to execute these traversals in parallel to speed up the execution time and is performed for each entry element identified for the specific pattern.

In step 3, for each entry element, parallize-traverse all instances and create temporary and placeholders (if necessary).

In step 4, data may be filter by associated data.

In step 5, results may be collected, new elements may be created, and associated data may be determined/computed.

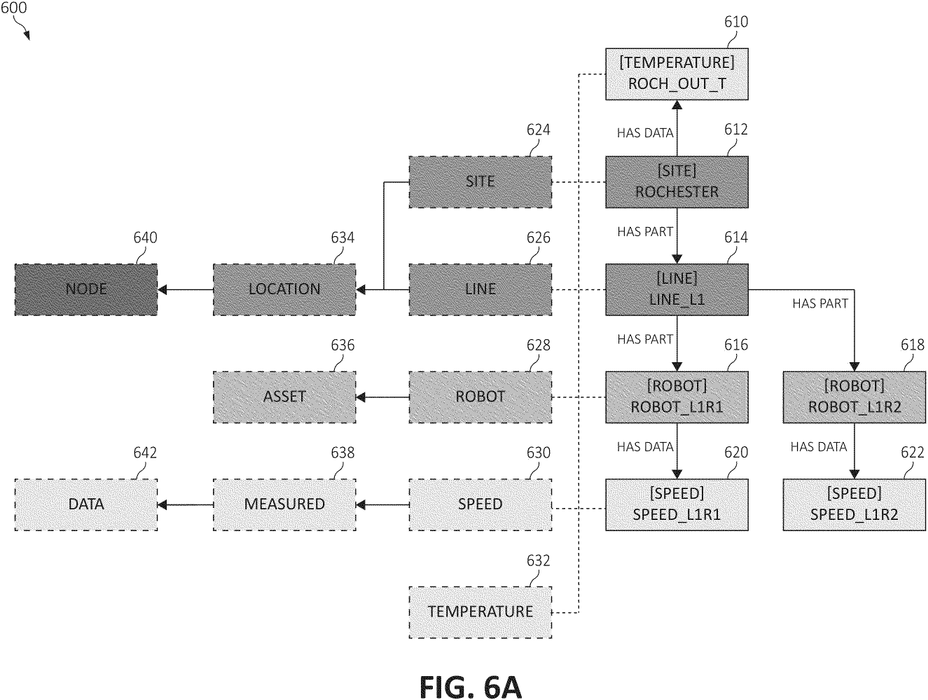

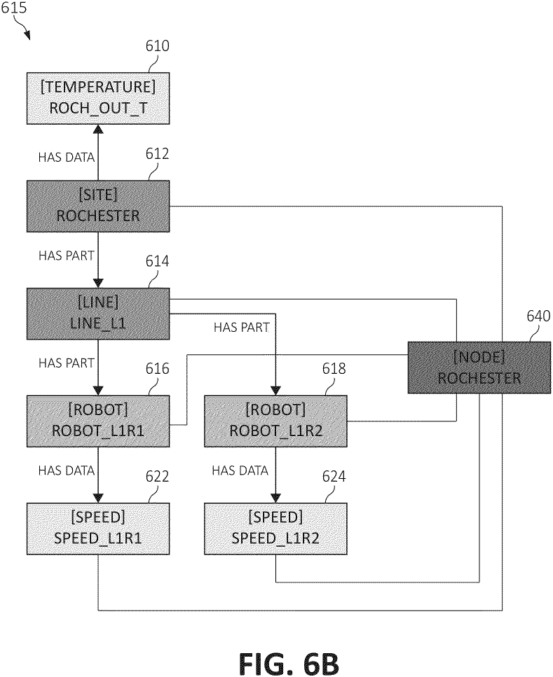

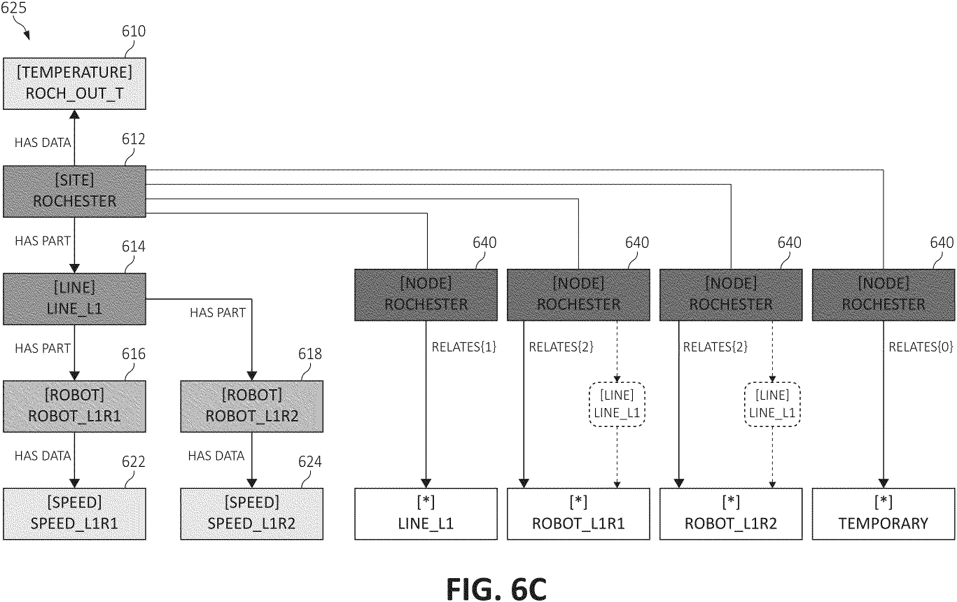

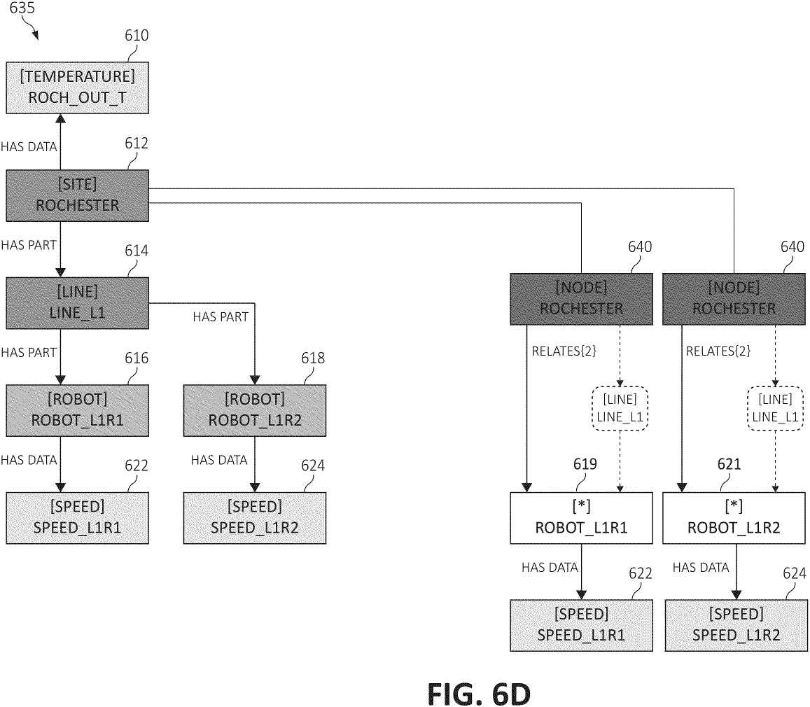

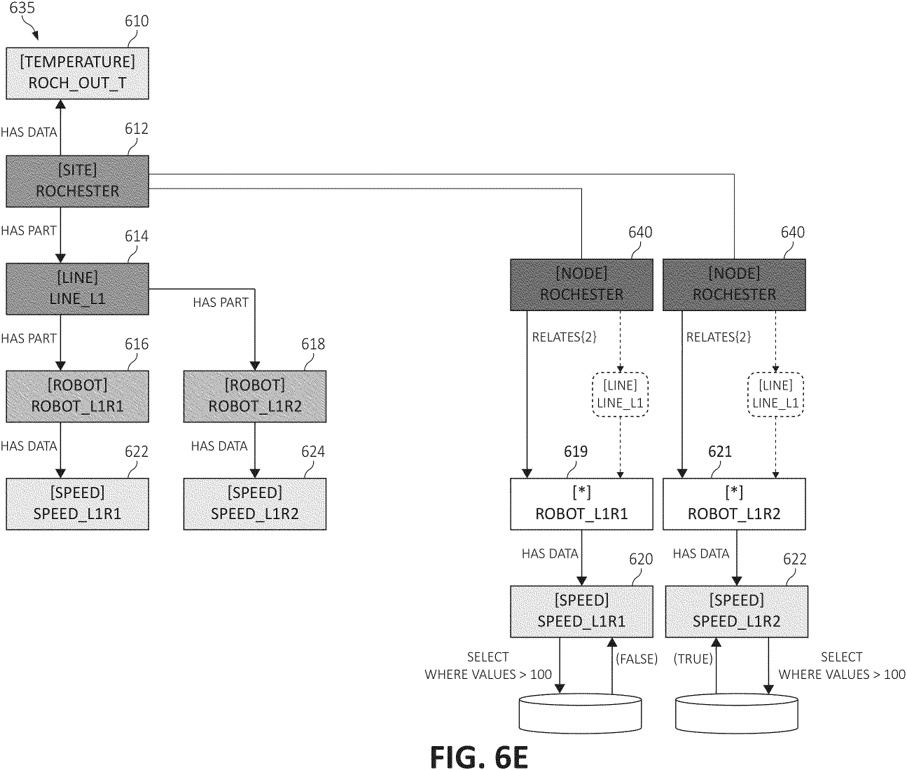

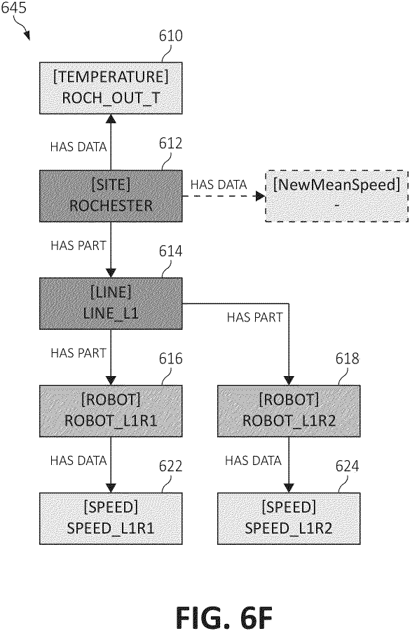

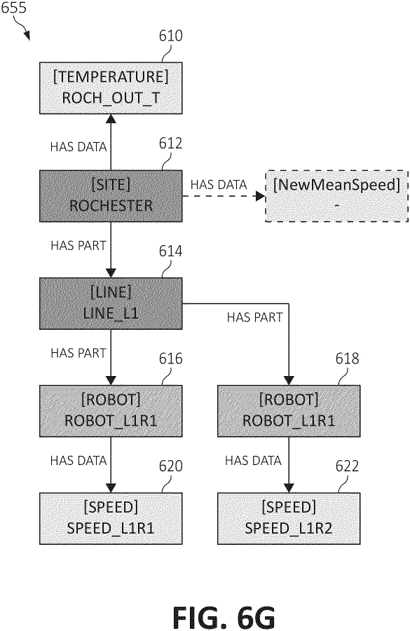

More specifically, starting in block 510, a starting entry element may be identified. A determination operation is performed to determine if there is a relationship and target of type, as in block 512. If no at block 512, a determination operation is performed to determine if a relationship and target of type be created (“+op”) (e.g., where +op is an abbreviation that indicates and add operation (“+”) and thus when the input pattern is resolved such as, for example, the “+” symbol indicates that the following edges and nodes will need to be created and appended in an original graph (refere to +hasData +new=MeanSpeed and FIG. 6G), as block 514. If yes at block 514, one or more temporary and placeholder relationships may be created. If no at block 514, a determination operation is performed to determine if creating the one or more temporary and placeholder relationships is optiona (e.g., zero multiplicity), as in block 516.

If yes at block 516, a temporary relationship may be created, as in block 520. If no at block 516, the block flow may move to block 540 and indicate/mark a result set as invalid.

From blocks 518, 520, and 512, a reference filter may be applied, as in block 522. In one aspect, a reference filter is an operation performed on the resultset whose objective is to filter out nodes from the result based on the presence (or absence) of outgoing edges associated to such node.

In block 524, a a determination operation is performed to determine if there is an instance for the starting entry element. If no at block 524, a determination operation is performed to determine if an instance for any of the elements is to be created (“+op”), as block 526.

If yes at block 526, one or more temporary and placeholder relationships may be created. If no at block 526, a determination operation is performed to determine if creating the one or more temporary and placeholder relationships is optional (e.g., zero multiplicity), as in block 526. If no at block 528, the block flow may move to block 540 and indicate/mark a result set as invalid. If yes at block 528, a temporary relationship may be created, as in block 532.

If yes, at block 524, an instance filter may be applied, as in block 534. Also, blocks 530 and 532 may move to block 534. In block 536, all associated data may be collected (e.g., collected from external sources.

A determination operation is performerd to determine if any data filters apply, as in block 538. If no at block 538, the block flow may move to block 540 and indicate/mark a result set as invalid. Block 540 may move to block 542. If yes at block 538, a determination operation is performed to determine if the entry element repeats or has sub-levels, as in block 542 (e.g., the pattern that is being looked/searched for in the graph may be complex and present multiple levels or require recursive matching/filtering to be resolved and block 542 accounts for the need of repeating the whole matching steps untile the full pattern is resolved). If yes, the block flow may move back to block 512. If no at block 542, one or more invalid results may be dropped or eliminated, as in block 544. That is, as in FIG. 6D, the appendix depicts that nodes of the graph that are not matching the input pattern to the system are dropped from the result set. In that particular instance, for example, the the pattern that is being looked/searched for in the graph is “all nodes associated to the Rochester [node] and that have a link to a [Speed] data node” so the first and last results are not matching results hence they are dropped.

One or more placeholder relationships may be instantiated, as in block 548.

In block 550, one or more equations may be evaluated (e.g., the equations may be equations to evaluate any data transformation step indicated as part of the input pattern. For example, a SET step may be used, indicated, or specified that transforms the data retrieved from the database according to some function specified in the FUNCTION block of the input).

The data may be stored, as in block 552. A backtrack path may be executed, as in block 554. That is, for each of the results, the present inventin is not only interested in retrieving a last visited element (e.g. a node) but the present invention also retrieves the original path from the starting element up to this final node via the backtrack path (e.g., Rochester->Line_L1->Robot_L1R1->Speed_L1R1).

The results from the batches may be collected, as in block 556. All matching results may be returned, as in block 558. That is, the results that are returned are a set of nodes and relationships that satisfy the input query to the system).

For further explanations, FIGS. 6A-6G are additional block diagrams depicting identifying relevant graph patterns in a knowledge graph in accordance with aspects of the present invention. It should be noted that FIGS. 6A-6G depict a sample knowledge graph 600 of a location hierarchy for a factory. The operations described in FIG. 5 are described in more detail using the example of FIGS. 6A-6G.

FIG. 6A depicts a sample knowledge graph 600 of a location hierarchy for a factory. The knowledge graph consists of a small location hierarchy consisting of a site “Rochester” with a temperature time series as well as a line ‘Line_L1’ and two robots ‘Robot_L1R1’ and ‘Robot_ L2R2’ with a speed sensor each as shown on the right side. The knowledge graph 600 may include a t-box terminological component (blocks 624-640), that define the concepts/terms used in the knowledge graph 600. The knowledge graph 600 also includes an a-box instance component (e.g., blocks 610-622). Within the t-box, the concepts for Site, Line, Robot, and Speed, and Temperature may be defined as sub-concepts of asset 636, location 634 and measured 638 and each of their super-concepts node 640 and data 642. Also, each temperature and speed sensor has timeseries data attached.

In one aspect, an example search query is depicted as pseudocode to further illustration the operations of FIG. 5 depicted in the example of FIGS. 6A-6G:

SEARCH:
Node | id=Rochester: # Conditional Filter that id eq. Rochester
hasPart{0,10}: # Relationship is optional
*: # Element can be of any type
hasData:
spd=Speed | values > 100 ms: # Conditional Filter o
underlying data
+hasData: # new relationship to be created
+new=NewMeanSpeed: # new data element to be created
SET:
new.values = ComputeFunction(spd.values): # Equation to compute new data from inputs
FUNCTION:
def ComputeFunction(inp):

FIG. 6B depicts operations 615 using the knowledge graph 600 for identifying one or more relevant entry elements (see step 510 of FIG. 5). The operations for identifying one or more relevant entry elements start by parsing the query in the above pseudocode (e.g., “SEARCH: Node | id=Rochester”). The first part of the query defines a search term ‘SEARCH’. Based on the first line of the query a start element in the knowledge graph 600 may be identified. The first line defines the search for an instance of “Node” that has the “id” equal to “Rochester” 612. Depending on the size of the knowledge graph and the restrictiveness, there may be one or multiple elements in the graph that match this search and that are defined as the set of entry points. At this point, the execution for each starting point may be parallelized. Using the example of FIGS. 6A-6G, there are only one element matching the entry point condition, which is the site Rochester 612.

Turning now to FIG. 6C, operations 625 is depicted using the knowledge graph 600 for a first iteration of [Parallel] Traversing optional relationship (step 2 of FIG. 5) to related instances (step 3 of FIG. 5). Referring to the above pseudocode, the next line in the search query ‘hasPart{0,10}’ defines to search for all outgoing relationships of type “hasPart” of search depth from lower bound 0 to higher bound 10. This search depth of the the knowledge graph 600 defines the number of successive occurence (e.g., property chain) of the relationship “hasPart”.

The knowledge graph 600 is traversed for all outgoing edges for each starting node in the knowledge graph, i.e. all “hasPart” relationships that are outgoing from Rochester to an instance of type “*” which stands for any type.

There is exactly one “hasPart” relationship (which is subtype to “relates”) leading to “Line_L1” 614. This is noted as a first partial result with depth “hasPart{ 1} to “Line_1” 614. Since there is a search depth of a higher bound greater than 1 (e.g., higher bound > 1), the operations continue looking for the next outgoing relationship of type “hasPart” from “Line_L1” 614. The operations may identify “Robot_L1R1” 616 and “Robot_L1R2” 618 and indicate and store this as additional partial result with depth “hasPart{2}”.

Since there is a search depth higher bound > 1, the operations continue looking in the knowledge graph 600 for the next outgoing relationship of “hasPart” from both. As there are no matching relationships, the traversal of the knowledge graph 600 is complete. Finally, considering there s lower bound of the search depth lower bound is 0, which implies the “hasPart” relationship may be optional. To address this situation and maintain consistency in the result structure, a “Temporary” relationship and temporary instance “*” that is pointing to Rochester 640 may be created. Thus, the processing for each partial result may be parallelized.

Turning now to FIG. 6D, operations 635 is depicted using the knowledge graph 600 for a second iteration of [Parallel] Traversing optional relationship (step 2 of FIG. 5) to related instances (step 3 of FIG. 5). Referring to the above pseudocode, the next query line looks for outgoing edges of type “hasData” to an instance of type “Speed”. The operation starts at the four identified partial results “Line_L1” 614, “Robot_L1R1” 616 and “Robot_L1R2” 618 and the “Temporary” element pointing to “Rochester” 640. For each element, the operations may search, in parallel, for outgoing edges of type “hasData”.

As “Line_L1” 614 has no outgoing edge of that type, this branch may be dropped from the partial result set. “Robot_L1R1” 616 and “Robot_L1R2” 618, “Temporary” element pointing to “Rochester” 640 have outoing “hasData” edges.

In the next step, an operation verifies that the type of the target instances matches the type “Speed”. This is correct for both Robots (e.g., “Robot_L1R1” 619 and “Robot_L1R2” 621) from the rochester nodes 640 and it is identifed and noted that “Speed_L1R1” 622 and “Speed_L1R2” 624 are new partial results. The branch for “Temporary” may be dropped as the data connected to “Rochester” 640 is of type “Temperature” and thus does not match the type constraint.

Turning now to FIG. 6E, operations 645 is depicted using the knowledge graph 600 for filtering instances on associated data (see block 524 of FIG. 5). Referring to the above pseudocode, the second part of the query defines a constraint for the data associated to the identifies “Speed” sensors.

For example, the pseudocode query states “spd=Speed | values > 100 ms,” which states that all data needs to be larger than 100 (m/s). To evaluate this, the operations connect to a database (e.g., external/legacy source) associated to “Speed_L1R1”622 and “Speed_L1R2” 624 and generates an SQL query to validate above condition. In this example, it may be assumed that the SQL query returns “False” for “Speed_L1R1” 620 and “True” for “Speed_L2R2” 622. In consequence, the respective result branch may be dropped for “Speed_L1R1” 622. The final partial result matching all search conditions is the path from “Rochester” 618 to “Speed_L1R2”624 and the operation may assign it to variable “spd”.

Turning now to FIG. 6F, operations 655 is depicted using the knowledge graph 600 for creating placeholder relationships. Referring to the above pseudocode, the next two lines in the query note with the “+” operator (e.g., “+new=NewMeanSpeed”) missing relationships and instances in the knowledge graph 600 that should be created for all results matching the previous search in the event the if the relationships and instances not exist.

As the previous processing steps of the equation (e.g., the pseudocode steps) are parallized for all outgoing edges, the operations may execute this step (e.g., creating placeholder relationships) in parallel to the previous steps (e.g., operations of FIGS. 6B- 6D), thus the result path to “Speed_L1R2”may yet to be known. To address this, the operation may first search for an outgoing edge “hasData” from the starting element “Rochester” to an instance of type “NewMeanSpeed”. The operation may first identify, locate, or find a relationship “hasData” but, it leads to a “Temperature” data element. Therefore, a new temporary relationship “hasData” may be created and added to a new temporary instance “Rochester_NewMeanSpeed” of the type “NewMeanSpeed”. The new temporary instance may be assigned a new variable such as, for example, variable “new”. After completion of the full search, these temporary elements may be instantiated only for these final, valid result branches, which for this example the branch is “Speed_L1R2”624.

Turning now to FIG. 6G, operations 665 is depicted using the knowledge graph 600 for determining (e.g., computing) associated data. Referring to the above pseudocode, the final process is to determine the associated data for all elements defined in the SET section of the query using the functions defined in the FUNCTION section (e.g., the “def ComputeFunction(inp):” of the pseudocode).

In the given example, for all result set that need to be computed, new associated values are defined for all instances of the earlier assigned variable “new” from the values from the variable “spd” ussing the function “ComputeFunction”. As such, the operation may retrieve, in parallel, for each tuple (new, spd) in the result set, the data from the associated database to “spd”, process it via “ComputeFunction” and store it to the newly created database entry for “new”.

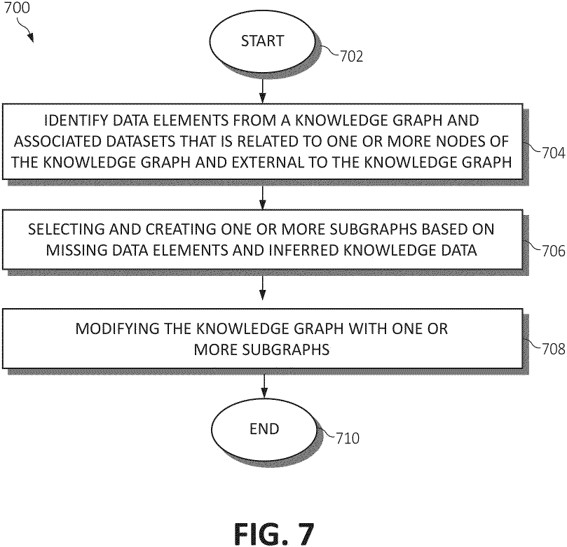

Turning now to FIG. 7, a method 700 for identifying relevant graph patterns in a knowledge graph in a computing environment is depicted, in which various aspects of the illustrated embodiments may be implemented. The functionality 700 may be implemented as a method executed as instructions on a machine, where the instructions are included on at least one computer readable medium or one non-transitory machine-readable storage medium. The functionality 700 may start in block 702.

Data elements may be identified from a knowledge graph and associated datasets that is related to one or more nodes of the knowledge graph and external to the knowledge graph, as in block 704. One or more subgraphs may be selected and created based on missing data elements and inferred knowledge data, as in block 706. The knowledge graph may be modified with one or more subgraphs, as in block 708. The functionality 700 may end, as in block 710.

In one aspect, in conjunction with and/or as part of at least one block of FIG. 7, the operation of 700 may include each of the following. The operation of 700 may infer knowledge data in the knowledge graph to instantiate missing data elemnets absent from the knowledge data. In some implementations, selecting and creating the one or more subgraphs further includes identifying one or more relevant data patterns and the associated data.

The operation of 700 may traverse the knowledge graph to identify relationships between the data elements and the associated datasets, wherein a filtering and multi-thread filtering operations are applied. The operation of 700 may create one or more temporary data elements and the missing data elements, and create one or more additional associated datasets.

The operation of 700 may apply one or more filters for selecting and prioritizing the associated datasets. The operation of 700 may identify one or more relationships between data elements and instances in the knowledge graph by traversing the knowledge graph; create one or more placeholders in the knowledge graph based on identifying the one or more relationships between the data elements and the instances; filter the associated datasets; and create one or more new data elements and new associated data based on the filtering and the one or more placeholders.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for identifying relevant graph patterns in a knowledge graph, comprising:
identifying data elements from a knowledge graph and associated datasets that is related to one or more nodes of the knowledge graph and external to the knowledge graph;
selecting and creating one or more subgraphs based on missing data elements and inferred knowledge data; and
modifying the knowledge graph with one or more subgraphs.

2. The method of claim 1, further including inferring knowledge data in the knowledge graph to instantiate missing data elemnets absent from the knowledge data.

3. The method of claim 1, wherein selecting and creating the one or more subgraphs identifying one or more relevant data patterns and the associated data.

4. The method of claim 1, further including traversing the knowledge graph to identify relationships between the data elements and the associated datasets, wherein a filtering and multi-thread filtering operations are applied.

5. The method of claim 1, further including:
creating one or more temporary data elements and the missing data elements; and
creating one or more additional associated datasets.

6. The method of claim 1, further including applying one or more filters for selecting and prioritizing the associated datasets.

7. The method of claim 1, further including:
identifying one or more relationships between data elements and instances in the knowledge graph by traversing the knowledge graph;
creating one or more placeholders in the knowledge graph based on identifying the one or more relationships between the data elements and the instances;
filtering the associated datasets; and
creating one or more new data elements and new associated data based on the filtering and the one or more placeholders.

8. A system for identifying relevant graph patterns in a knowledge graph in a computing environment, comprising:
one or more computers with executable instructions that when executed cause the system to:
identify data elements from a knowledge graph and associated datasets that is related to one or more nodes of the knowledge graph and external to the knowledge graph;
select and create one or more subgraphs based on missing data elements and inferred knowledge data; and
modify the knowledge graph with one or more subgraphs.

9. The system of claim 8, wherein the executable instructions when executed cause the system to infer knowledge data in the knowledge graph to instantiate missing data elemnets absent from the knowledge data.

10. The system of claim 8, wherein selecting and creating the one or more subgraphs further includes identifying one or more relevant data patterns and the associated data.

11. The system of claim 8, wherein the executable instructions when executed cause the system to traverse the knowledge graph to identify relationships between the data elements and the associated datasets, wherein a filtering and multi-thread filtering operations are applied.

12. The system of claim 8, wherein the executable instructions when executed cause the system to:
create one or more temporary data elements and the missing data elements; and
create one or more additional associated datasets.

13. The system of claim 8, wherein the executable instructions when executed cause the system to apply one or more filters for selecting and prioritizing the associated datasets.

14. The system of claim 8, wherein the executable instructions when executed cause the system to:
identify one or more relationships between data elements and instances in the knowledge graph by traversing the knowledge graph;
create one or more placeholders in the knowledge graph based on identifying the one or more relationships between the data elements and the instances;
filter the associated datasets; and
create one or more new data elements and new associated data based on the filtering and the one or more placeholders.

15. A computer program product for identifying relevant graph patterns in a knowledge graph in a computing environment, the computer program product comprising:
one or more computer readable storage media, and program instructions collectively stored on the one or more computer readable storage media, the program instruction comprising:
program instructions to identify data elements from a knowledge graph and associated datasets that is related to one or more nodes of the knowledge graph and external to the knowledge graph;
program instructions to select and create one or more subgraphs based on missing data elements and inferred knowledge data; and
program instructions to modify the knowledge graph with one or more subgraphs.

16. The computer program product of claim 15, further including program instructions to:
infer knowledge data in the knowledge graph to instantiate missing data elemnets absent from the knowledge data; and
identify one or more relevant data patterns and the associated data.

17. The computer program product of claim 15, further including program instructions to traverse the knowledge graph to identify relationships between the data elements and the associated datasets, wherein a filtering and multi-thread filtering operations are applied.

18. The computer program product of claim 15, further including program instructions to: create one or more temporary data elements and the missing data elements; and create one or more additional associated datasets.

19. The computer program product of claim 15, further including program instructions to apply one or more filters for selecting and prioritizing the associated datasets.

20. The computer program product of claim 15, further including program instructions to:
identify one or more relationships between data elements and instances in the knowledge graph by traversing the knowledge graph;
create one or more placeholders in the knowledge graph based on identifying the one or more relationships between the data elements and the instances;
filter the associated datasets; and
create one or more new data elements and new associated data based on the filtering and the one or more placeholders.
